(19) United States
(12) Patent Application Publication
(10) Pub. No.: US 2022/0174908 A1
(43) Pub. Date: Jun. 9, 2022

(54) Temperature Controlled Pet Bed System

(71) Applicant: Summit Seeker Solutions LLC, Flint, TX (US)

(72) Inventor: David B. Hamlin, Flint, TX (US)

(21) Appl. No.: 17/112,353

(22) Filed: Dec. 4, 2020

(51) Int. Cl. A01K 1/035; A01K 1/00

(52) U.S. Cl. CPC A01K 1/0353; A01K 1/0076; A01K 1/0082

(57) ABSTRACT

A temperature-controlled pet bed system includes an electrically powered cooling unit. The cooling unit has a compressor, a condenser, a refrigerant metering device, and an evaporator that are fluidly coupled together to allow a refrigerant to flow through the cooling unit in a refrigeration cycle. A pet bed assembly of the system is configured to rest upon a support surface. The pet bed assembly has an upper bed pad containing or being configured to contain a heat sink liquid to facilitate dissipation of heat and/or cold within the upper bed pad to avoid concentrated areas of hot and/or cold from forming on the upper bed pad. The pet bed assembly further includes a lower bed support that supports the upper bed pad. The lower bed support contains the evaporator of the cooling unit. The evaporator is positioned adjacent to and below the upper bed pad so that heat is transferred between the upper bed pad and the evaporator to facilitate cooling of the upper bed pad.

### BACKGROUND

With the increasing pet population in the U.S., more pet owners are seeking products that will keep their pet(s) comfortable in both hot and cold ambient conditions, with little to no intervention required by the pet owner. Even more so, service dog trainers, breeders, show handlers, veterinarians and boarding house owners consider keeping their animals cool in the heat of the summer as more of a matter of safety than comfort. While there are a number of products directed to keeping a pet comfortable across a broad temperature spectrum, most of these products use cooling methods that are temporary and unsustainable, typically applying ice or frozen gel packs.

One such cooled pet bed is described in U.S. Pat. No. 4,064,835 to Rabenbauer. As described, a reusable ice pack is installed just below a platform on which the pet lies. U.S. Pat. No. 4,899,693 to Arnold discloses a cooled pet bed which includes a recess that receives a container of ice. U.S. Pat. No. 5,727,503 to Whitaker is another pet cooling system which uses an ice cartridge storage body. U.S. Pat. No. 7,730,740 to Keller teaches a cooling device for a pet carrier using ice as the cooling medium, while U.S. Pat. No. 8,567,347 to Leahy et al. discloses a pet cooling station that uses a conductive metal platform and ice packs. U.S. Pat. No. 6,647.924 to Zwicker et al. describes an animal shelter which can be filled with a cooling gel material. For these cases, there is no use of a mechanical refrigerant system to directly cool the pet bed, thus requiring constant maintenance in order to deliver sufficient and continuous cooling capacity to the pet. Furthermore, there is no way to adequately regulate or adjust the amount of cooling provided by these systems.

“Active” cooling methods for pets, which use mechanical refrigeration, are limited to devices which require a secondary cooling loop by means of a liquid pump or the use of cooling air. For example, U.S. Pat. No. 8,011,204 to Kissel, Jr. discloses a kennel bed chiller system for controlling the temperature of a series of interconnected kennels using a cooling water loop. U.S. Pat. No. 10,278,511 uses a thermoelectric unit and a hydraulic circuit to condition the surface of an article, while U.S. Pat. No. 6,237,531 to Peeples et al. uses a thermoelectric unit and ducted, conditioned air to cool or heat the surface of the pet bed platform. For pet bed applications, thermoelectric units provide weak cooling output for their physical size. Also, inventions with chill water loops that require a circulating pump are less reliable and prone to leaks over the life of the product.

From a heating perspective, other inventions use water-filled beds, but with an electric, resistance heater which has been common in human water beds for years. U.S. Pat. Nos. 4,332,214 and 4,591,694 describe such heating methods.

The present invention is unique in that it overcomes the aforementioned shortcomings.

### BRIEF DESCRIPTION OF THE DRAWINGS

For a more complete understanding of the embodiments described herein, and the advantages thereof, reference is now made to the following descriptions taken in conjunction with the accompanying figures, in which:

FIG. 1 is a perspective view of a temperature-controlled pet bed system constructed in accordance with particular embodiments of the invention;

FIG. 2 is a cross-sectional, elevational view of an upper bed pad and a lower bed support of the pet bed system of FIG. 1; and

FIG. 3 is a cross-sectional, elevational view of a temperature-controlled pet bed system constructed in accordance with another embodiment of the invention.

### DETAILED DESCRIPTION

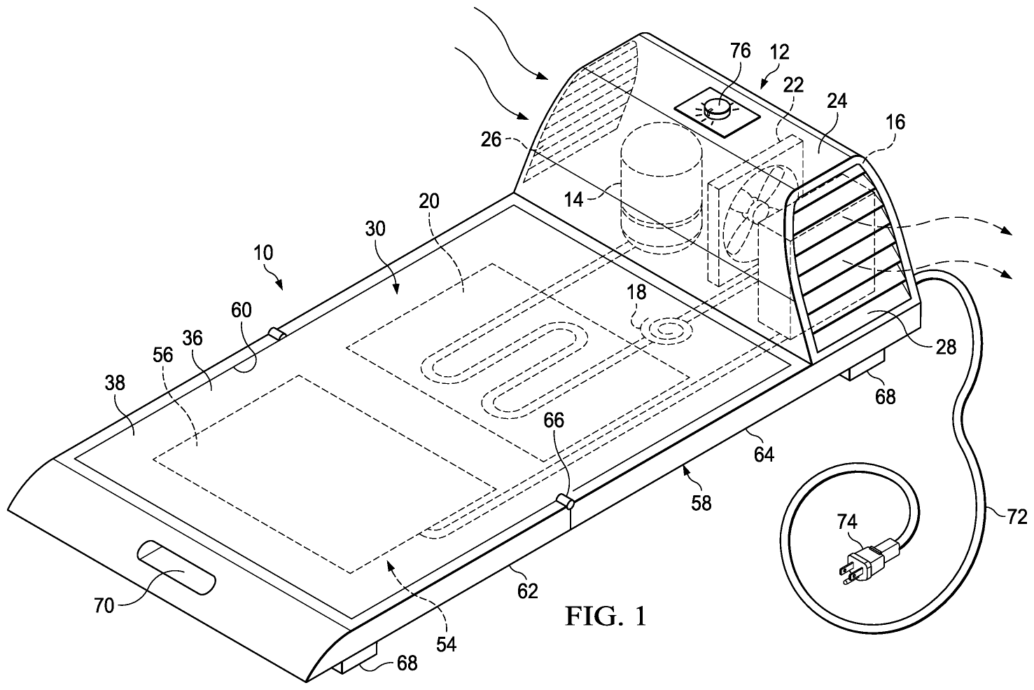

Referring to FIG. 1, a temperature-controlled pet bed system 10 is shown. The system 10 includes a cooling unit 12 that facilitates cooling of a pet bed of the system 10. The cooling unit 12 constitutes a refrigeration circuit and includes a compressor 14, a condenser 16, a refrigerant metering device 18, and an evaporator 20.

The cooling unit or refrigerant circuit 12 may be similar to those commonly found in small refrigerators and beverage coolers. The compressor 14 may be a reciprocating- or rotary-type compressor and may be small and compact in size to reduce weight and space consumption. The condenser 16 may be a coil condenser with a fan 22, which may be separate or integrated with the condenser, for providing an airflow over the condenser coils of the condenser 16 for forced convective heat transfer.

As shown, a cooling unit housing or cover 24 encloses or houses the compressor 14, condenser 16 and fan 22 of the cooling unit 12. The housing 24 may be vented or provided with an air inlet 26 for drawing in ambient air into the housing 24 that is drawn by the fan 22 and directed over the condenser coils of condenser 16. The air passing over the condenser 16 is then exhausted through vents or exhaust air outlet 28 of the housing 24. The housing 24 may be constructed from a variety of materials, such as molded plastic or polymeric materials, fiberglass, metal, etc., or combinations of such materials. The housing 24 may also be constructed and configured to prevent or minimize damage or unwanted access to the housing interior by the pet, such as by gnawing, chewing, clawing, etc.

The compressed and cooled refrigerant from condenser 16 is delivered to an evaporator 20 through the throttling or metering device 18. The metering device 18 limits the amount of refrigerant introduced into the evaporator 20 so that it works more efficiently and assists in maximizing or optimizing the amount of heat the evaporator 20 absorbs. The metering device 18 also reduces the pressure of the refrigerant from the condenser so that it expands within the evaporator 20, flashes to a vapor and absorbs heat during its change of state. In certain embodiments, a thermal expansion valve (TXV) or electronic expansion valve (EXV) may be used as the metering device 18. These are controllable or actuatable devices that can respond or adjust precisely to accommodate changes in the refrigeration system 12.

In many applications, however, the metering device 18 of the cooling unit 12 will be a capillary tube. The capillary tube 18 is a non-actuatable metering device meaning that the refrigerant flow is not controlled or adjusted, such as through an adjustable control valve. The use of a capillary tube 18 for the system 10 is advantageous, however, because it is typically of lower cost, simple in design, and has no moving parts. The capillary tube is also more reliable, reduces the load on the compressor during startups, eliminates the need for a refrigerant receiver, and is typically well suited for smaller cooling systems, such as the pet bed system 10.

The capillary tube 18 is typically a length of copper, aluminum or other metal tubing having a very small inner diameter. The capillary tube 18 operates by allowing refrigerant from the condenser 16 to flow through the small diameter of the capillary tube 18, which thereby increases the velocity of the refrigerant resulting in a pressure drop. This in turn results in the metering, expansion, change of state and heat absorption in the refrigerant.

The length and diameter of the capillary tube 18 may vary depending upon the requirements and capacity of the cooling unit 12. In particular embodiments, the capillary tube 18 may have an overall length or flow passage length of from 2 ft to 20 ft. In some instances, the overall length of the capillary tube 18 or flow passage may be at least, equal to, and/or between any two of 2 ft, 3 ft, 4 ft, 5 ft, 6 ft, 7 ft, 8 ft, 9 ft, 10 ft, 11 ft, 12 ft, 13 ft, 14 ft, 15 ft, 16 ft, 17 ft, 18 ft, 19 ft, and 20 ft. The capillary tube 18 may have an inner diameter along all or a portion of its length of from 0.010 inch to 0.150 inch. In certain cases, the capillary tube 18 may have an inner diameter along all or a portion of its length of at least, equal to, and/or between any two of 0.010 inch, 0.015 inch, 0.020 inch, 0.025 inch, 0.030 inch, 0.035 inch, 0.040 inch, 0.045 inch, 0.050 inch, 0.055 inch, 0.060 inch, 0.065 inch, 0.070 inch, 0.075 inch, 0.080 inch, 0.085 inch, 0.090 inch, 0.095 inch, 0.100 inch, 0.105 inch, 0.110 inch, 0.115 inch, 0.120 inch, 0.125 inch, 0.130 inch, 0.135 inch, 0.140 inch, 0.145 inch, and 0.150 inch. The capillary tube 18 will often be in a coiled configuration so that it is more compact and occupies less space.

It should be noted in the description, if a numerical value or range is presented, each numerical value should be read once as modified by the term “about” (unless already expressly so modified), and then read again as not so modified unless otherwise indicated in context. Also, in the description, it should be understood that an amount range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific points within the range, or even no point within the range, are explicitly identified or referred to, it is to be understood that the inventor appreciates and understands that any and all points within the range are to be considered to have been specified, and that inventor possesses the entire range and all points within the range, including smaller ranges within the larger ranges.

The evaporator 20 of the cooling unit 12 may be in the form of an evaporator plate. The evaporator plate 20 may have a plate- or sheet-like configuration that is relatively thin so that it can underlie and be embedded in the bed pad and bed support of the system 10, as are described later on. All or portions of the evaporator plate 20 may be formed from aluminum, copper or other metal or material having a relatively high thermal conductivity. The plate evaporator 20 may be formed by two or more evaporator plate or sheet members that are sandwiched together and are shaped or configured with raised areas or ridges that form recesses or channels that define refrigerant flow passages that extend over the width and length of the evaporator plate 20, such as in an undulating, back-and-forth looped, or serpentine fashion. In some embodiments, the evaporator plate 20 may be formed from one or more lengths of copper, aluminum or other metal tubing that is/are bent or shaped in an undulating, looped, or serpentine configuration. The tubing may be coupled to or otherwise incorporated into one or more sheets or plates, formed from one or more sheet or plate members of the same or a different metal, or the tubing may directly contact or be incorporated with the pet bed pad without sheets or plates.

The evaporator plate 20 may have an overall planar or flat, curved or contoured configuration to accommodate selected shapes or contours of the pet bed pads, as are described later. All or portions of the evaporator plate 10 may have thickness across its width and/or length of from 0.5 inch or less. In particular embodiments, all or portions of the evaporator plate 20 may have a thickness equal to, and/or between any two of 0.020 inch, 0.025 inch, 0.030 inch, 0.035 inch, 0.040 inch, 0.045 inch, 0.050 inch, 0.055 inch, 0.060 inch, 0.065 inch, 0.070 inch, 0.075 inch, 0.080 inch, 0.085 inch, 0.090 inch, 0.095 inch, 0.100 inch, 0.105 inch, 0.110 inch, 0.115 inch, 0.120 inch, 0.125 inch, 0.130 inch, 0.135 inch, 0.140 inch, 0.145 inch, 0.150 inch, 0.155 inch, 0.160 inch, 0.165 inch, 0.170 inch, 0.175 inch, 0.180 inch, 0.185 inch, 0.190 inch, 0.195 inch, 0.200 inch, 0.200 inch, 0.205 inch, 0.210 inch, 0.215 inch, 0.220 inch, 0.225 inch, 0.230 inch, 0.235 inch, 0.240 inch, 0.245 inch, 0.250 inch, 0.255 inch, 0.260 inch, 0.265 inch, 0.270 inch, 0.275 inch, 0.280 inch, 0.285 inch, 0.290 inch, 0.295 inch, 0.300 inch, 0.305 inch, 0.310 inch, 0.315 inch, 0.320 inch, 0.325 inch, 0.330 inch, 0.335 inch, 0.340 inch, 0.345 inch, 0.350 inch, 0.355 inch, 0.360 inch, 0.365 inch, 0.370 inch, 0.375 inch, 0.380 inch, 0.385 inch, 0.390 inch, 0.395 inch, 0.400 inch, 0.405 inch, 0.410 inch, 0.415 inch, 0.420 inch, 0.425 inch, 0.430 inch, 0.435 inch, 0.440 inch, 0.445 inch, 0.450 inch, 0.455 inch, 0.460 inch, 0.465 inch, 0.470 inch, 0.475 inch, 0.480 inch, 0.485 inch, 0.490 inch, 0.495 inch, and 0.500 inch. Areas of higher thickness may constitute the refrigerant flow passages of the evaporator plate 20, while thinner areas of thickness may constitute the portions of the plate or sheet members between the flow passages.

In lieu of an evaporator plate, a copper, aluminum or other metal tube evaporator without sheet or plate members could also be used for the evaporator 20. Such tube evaporator 20 will typically be one or more tubes that are configured in an undulating, back-and-forth looped, or serpentine configuration, with the tubes or tube portions being arranged in side-by side manner. The tube assembly of the evaporator 20 may be configured with the tubes or tube portions arranged in a generally planar or flat, curved or contoured configuration to accommodate selected shapes or contours of the pet bed pads. Such tube evaporator assembly 20 may have the same or similar thicknesses across its width and/or length to that of the evaporator plate described previously.

The refrigerant used may be a HFC- or CFC-type refrigerant, such as R-410A, R-134a, etc., or a more environmental friendly refrigerant with low global warming potential (GWP), such as an HC refrigerant, like isobutane (e.g., R-600a), propane (e.g., R-290) or cyclopentane.

In certain applications, the refrigeration circuit 12 may be one that provides a maximum refrigeration capacity of from 1500 Btu/hr or less. In certain embodiments, the refrigeration capacity of the refrigeration circuit 12 may be from at least, equal to, and/or between any two of 100 Btu/hr, 110 Btu/hr, 120 Btu/hr, 130 Btu/hr, 140 Btu/hr, 150 Btu/hr, 160 Btu/hr, 170 Btu/hr, 180 Btu/hr, 190 Btu/hr, 200 Btu/hr, 210 Btu/hr, 220 Btu/hr, 230 Btu/hr, 240 Btu/hr, 250 Btu/hr, 260 Btu/hr, 270 Btu/hr, 280 Btu/hr, 290 Btu/hr, 300 Btu/hr, 310 Btu/hr, 320 Btu/hr, 330 Btu/hr, 340 Btu/hr, 350 Btu/hr, 360 Btu/hr, 370 Btu/hr, 380 Btu/hr, 390 Btu/hr, 400 Btu/hr, 410 Btu/hr, 420 Btu/hr, 430 Btu/hr, 440 Btu/hr, 450 Btu/hr, 460 Btu/hr, 470 Btu/hr, 480 Btu/hr, 490 Btu/hr, 500 Btu/hr, 510 Btu/hr, 520 Btu/hr, 530 Btu/hr, 540 Btu/hr, 550 Btu/hr, 560 Btu/hr, 570 Btu/hr, 580 Btu/hr, 590 Btu/hr, 600 Btu/hr, 610 Btu/hr, 620 Btu/hr, 630 Btu/hr, 640 Btu/hr, 650 Btu/hr, 660 Btu/hr, 670 Btu/hr, 680 Btu/hr, 690 Btu/hr, 700 Btu/hr, 710 Btu/hr, 720 Btu/hr, 730 Btu/hr, 740 Btu/hr, 750 Btu/hr, 760 Btu/hr, 770 Btu/hr, 780 Btu/hr, 790 Btu/hr, 800 Btu/hr, 810 Btu/hr, 820 Btu/hr, 830 Btu/hr, 840 Btu/hr, 850 Btu/hr, 860 Btu/hr, 870 Btu/hr, 880 Btu/hr, 890 Btu/hr, 900 Btu/hr, 910 Btu/hr, 920 Btu/hr, 930 Btu/hr, 940 Btu/hr, 950 Btu/hr, 960 Btu/hr, 970 Btu/hr, 980 Btu/hr, 990 Btu/hr, 1000 Btu/hr, 1010 Btu/hr, 1020 Btu/hr, 1030 Btu/hr, 1040 Btu/hr, 1050 Btu/hr, 1060 Btu/hr, 1070 Btu/hr, 1080 Btu/hr, 1090 Btu/hr, 1100 Btu/hr, 1110 Btu/hr, 1120 Btu/hr, 1130 Btu/hr, 1140 Btu/hr, 1150 Btu/hr, 1160 Btu/hr, 1170 Btu/hr, 1180 Btu/hr, 1190 Btu/hr, 1200 Btu/hr, 1210 Btu/hr, 1220 Btu/hr, 1230 Btu/hr, 1240 Btu/hr, 1250 Btu/hr, 1260 Btu/hr, 1270 Btu/hr, 1280 Btu/hr, 1290 Btu/hr, 1300 Btu/hr, 1310 Btu/hr, 1320 Btu/hr, 1330 Btu/hr, 1340 Btu/hr, 1350 Btu/hr, 1360 Btu/hr, 1370 Btu/hr, 1380 Btu/hr, 1390 Btu/hr, 1400 Btu/hr, 1410 Btu/hr, 1420 Btu/hr, 1430 Btu/hr, 1440 Btu/hr, 1450 Btu/hr, 1460 Btu/hr, 1470 Btu/hr, 1480 Btu/hr, 1490 Btu/hr, and 1500 Btu/hr.

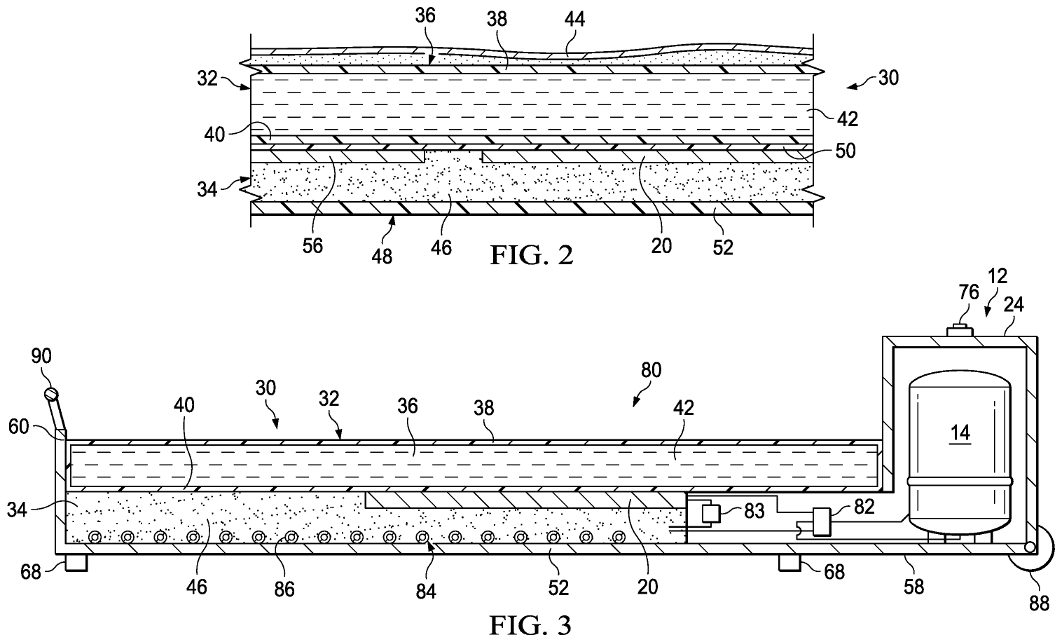

The pet bed cooling system 10 further includes a pet bed assembly 30. As shown in FIG. 2, the pet bed assembly 30 is formed from an upper bed pad 32 and a lower bed support 34. The upper bed pad 32 and lower bed support 34 may be separate bodies that are separate and removable from one another. In other embodiments, the pad 32 and support 34 may be removably or non-removably coupled to one another. The upper bed pad 32 is formed with an outer shell 36 having upper and lower shell walls 38, 40, respectively. The walls 38, 40 or portions thereof may be formed from a rigid or flexible, liquid impermeable sheet or panel material. The walls 38, 40 may be formed from the same or a different material. This can include non-metal materials, such as a plastic or polymeric material or a composite polymeric material, such as a polymer/fabric composite. Non-limiting examples of such materials include polyvinyl chloride (PVC), latex, nylon, polyester, polyethylene (e.g., LDPE, HDPE, etc.), polypropylene, etc. The walls 38, 40 may also be formed from metal sheet material, such as copper, aluminum, steel, stainless steel, etc. Metal materials may allow better heat transfer through the upper bed pad 32. In some embodiments, all or portions of the upper shell wall 38 may be formed from a non-metal or polymeric material, while all or portions of the lower shell wall 40 may formed from a metal material. In particular embodiments, both the shell walls 38, 40 are formed from a rigid, food-grade, UV-resistant polyethylene.

The shell materials for the walls 38, 40 should be strong and durable, as well as tear and puncture resistant, so they are not readily damaged during use. This would include good resistance to biting, clawing, scratching, or tearing, by the pet for which the pet bed system 10 is to be used. Polymeric/fabric composites may therefore be particularly useful for the walls 38, 40, where flexible walls are used, either as separate composite layers that are sandwiched or laminated together or polymer-impregnated fabrics, or combinations of these materials, to increase their strength and durability. The shell materials should also have good resistance to damage from long-term exposure to extreme environmental conditions, such as moisture, cold, heat, UV light, etc. The upper and lower shell walls 38, 40 may each be selected and configured so that they do not significantly insulate or prevent heat transfer to thus impede or interfere with the purpose and functioning of the system 10.

The upper and lower shell walls 38, 40 are joined together around their perimeters and define an interior of the shell 36. The interior of the shell 36 is filled with a thermal heat sink material 42. The thermal heat sink material 42 is typically a liquid but could also be a solid or semi-solid material in some instances. A sealable nozzle or inlet (not shown) may be provided in the shell 36 to allow for introducing or draining the thermal heat sink liquid into and from the interior of the shell 36. The volume of the filled interior of the shell 36 may range from 0.5 gallon to 10 gallons, with from 1 gallon to 5 gallons being typical. In certain embodiments, the volume of the filled interior of the shell 36 may be from at least, equal to, and/or between any two of 0.5 gallon, 1.0 gallon, 1.5 gallons, 2.0 gallons, 2.5 gallons, 3.0 gallons, 3.5 gallons, 4.0 gallons, 4.5 gallons, 5.0 gallons, 5.5 gallons, 6.0 gallons, 6.5 gallons, 7.0 gallons, 7.5 gallons, 8.0 gallons, 8.5 gallons, 9.0 gallons, 9.5 gallons, and 10.0 gallons.

The heat sink liquid 42 can be any liquid that facilitates dissipation of heat and/or cold within the upper bed pad 32 to avoid concentrated areas of hot and/or cold from forming in the upper bed pad 32, as well as to slow extreme temperature changes. In most cases this will be water (e.g., fresh water) or an aqueous solution or mixture. Such aqueous solutions or mixtures may include salt water (e.g., saline) or brine, water/alcohol (e.g., isopropanol, ethanol, etc.), water/antifreeze (e.g., propylene glycol, glycerol, etc.). The compounds used in such aqueous liquids may suppress or lower the freezing point of the liquid and/or increase the liquid boiling point, with no or minimal reduction of heat capacity (i.e., from 30%, 25%, 20%, 15%, 10%, 5% or less reduction of heat capacity) of the liquid relative to fresh water. The liquid 42 can have a fairly low viscosity, such as that of water, or it may have a higher viscosity, such as a gel material. In certain instances, a gelling agent may be added to the water or aqueous solution, such as to give the upper pad 32 a higher firmness, where flexible walls are used for the shell 36. Examples of such gelling agents may include hydroxycellulose, xanthan gum, guar gum, agar, carrageenan, polyacrylic acid, etc. In many applications, the heat sink liquid 42 will be non-toxic liquid so that liquid leakage does not present any safety concerns to humans or animals.

The upper bed pad 32 may have a thickness when filled with the heat sink liquid 42 of from ¼ inch to 3 inches. In certain embodiments, the upper bed pad 32 may have a thickness when filled with the liquid 42 of at least equal to, and/or between any two of ¼ inch. ½ inch, ¾ inch, 1 inch, 1¼ inch, 1½ inch, 1¾ inch, 2 inches, 2¼ inches, 2½ inches, 2¾, and 3 inches. If flexible materials for the walls 38, 40 are used, at higher thicknesses of the pad 32, internal structures such as ribs, pillars, members, etc., may be used to stabilize the walls 38, 40 so that the upper bed pad 32 has a solid or firm feel and less of a wavy or “water bed” feel, which some pets may dislike.

The dimensions of the bed pad 32 will vary depending upon its use and application and the size of the pet for which it is to be used. In certain embodiments, the length and/or width may range from 10 inches to 72 inches or more. In some instances, the bed pad 32 may have length and/or width of at least equal to, and/or between any two of 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, 25 inches, 26 inches, 27 inches, 28 inches, 29 inches, 30 inches, 31 inches, 32 inches, 33 inches, 34 inches, 35 inches, 36 inches, 37 inches, 38 inches, 39 inches, 40 inches, 41 inches, 42 inches, 43 inches, 44 inches, 45 inches, 46 inches, 47 inches, 48 inches, 49 inches, 50 inches, 51 inches, 52 inches, 53 inches, 54 inches, 55 inches, 56 inches, 57 inches, 58 inches, 59 inches, 60 inches, 61 inches, 62 inches, 63 inches, 64 inches, 65 inches, 66 inches, 67 inches, 68 inches, 69 inches, 70 inches, 71 inches, and 72 inches. In particular applications, a suitable size for the bed pad 32 is that with length of from 20 inches to 48 inches and a width of from 12 to 30 inches.

In certain embodiments, a separate cover, cushion or pad 44 may be provided with the system 10. The pad 44 may rest on the upper shell wall 38 of the upper bed pad 32 and be of the same or similar length and width. The pad 44 may be removable, removably coupled or non-removably coupled to the upper bed pad 32 or other portions of the system 10. The cover, pad or cushion 44 may be useful when the upper wall 38 is formed from hard, rigid materials, such as a rigid plastic or metal. In addition to providing a cushion for the pet, the pad 44 may also provide a degree of insulation from the wall materials 38, 40 that have a high thermal conductivity, such as metal, where the temperature of the upper wall 38 may be uncomfortable to the pet if the pet were to contact it directly. In other cases, the cover or cushion 44 may be selected and configured so that it does not significantly insulate or prevent heat transfer to thus impede or interfere with the purpose and function of the system 10, where materials of lower thermal conductivity are used for the walls 38, 40. The cover or cushion 44 may be a fabric cushion, such as those commonly used for pets. The cover or cushion 44 may also be elastomeric, such as rubber or silicone material, or include elastic portions, which allow the cushion 44 to be stretched or extended across the upper bed pad 32.

The lower bed support 34 of the pet bed assembly 30 underlies and supports the upper bed pad 32. All or portions of the lower bed support 34 are formed from an insulating material 46. This may be formed as a solid layer and include an open or closed cell foam insulating material. In certain embodiments, the insulating material 46 may be one or more layers of polystyrene or polyurethane foam material, which may be an expanded foam. Other insulating materials may include fiberglass, cellulose and cellulosic materials, natural fibers or particles (e.g., cotton, wool, straw, saw dust, hemp, etc.), cloth or fabric materials, etc.

The lower bed support 34 may include an outer shell 48 having upper and lower shell walls 50, 52, respectively. The upper and lower shell walls 50, 52 may be parallel to one another and be joined together around their perimeters to define an interior of the shell 48 that surrounds or encases the insulating material 46. The walls 50, 52 or portions thereof may be formed from a rigid or flexible, sheet or panel material. The walls 50, 52 may each be formed from the same or a different material. This can include non-metal materials, such as a plastic or polymeric material or a composite polymeric material, such as a polymer/fabric composite. Non-limiting examples of such materials include polyvinyl chloride (PVC), latex, nylon, polyester, polyethylene (e.g., LDPE, HDPE, etc.), polypropylene, etc. The walls 50, 52 may also be formed from metal sheet material, such as copper, aluminum, steel, stainless steel, etc. Metal materials may allow better heat transfer through the upper shell wall 50. In some embodiments, all or portions of the upper shell wall 50 may be formed from a metal material or a material with a high thermal conductivity, while the lower shell wall 52 may be formed from non-metal or polymeric material or a material with a lower thermal conductivity. The upper shell wall 50 is in direct contact with and abuts against or is immediately adjacent to the lower shell wall 40 of the upper bed support 32. In an alternate configuration, all or a portion of the upper shell wall 50 may form all or a portion of the lower shell wall 40 of the upper bed pad 32. Thus, the upper wall 50 of lower bed support 34 may also form the lower wall 40 of the upper bed pad 32.

As can be seen in FIG. 2, the evaporator plate 20 may be incorporated with, embedded or otherwise contained in the lower bed support 34. As shown, the evaporator plate 20 is parallel to and abuts against or is positioned immediately below the upper shell wall 50. This is also adjacent to and below the lower shell wall 40 of the upper bed pad 32, which may be the same or different than the shell wall 40, so that heat is readily transferred between the upper bed pad 32 and the evaporator 20 of the lower bed support 34 to facilitate cooling of the upper bed pad 32, as previously discussed. No or only a minor amount of insulating material 46 may be interspersed between the upper surface of the evaporator plate 20 and the upper shell wall 50. A sufficient amount of the insulating material 46 may surround or encase the ends and lower surface of the evaporator plate 20, however, so that the majority of heat transfer to and from the plate 20 is directed to and from its upper surface to the upper bed pad 32 and very little or minor amounts of heat is transferred through the thickness of the layer of insulation 46 below the plate 20.

During operation of the cooling unit 12, the evaporator plate 20 is cooled or chilled thus cooling the heat sink liquid 42 and the upper bed pad 32. The evaporator plate 20 is sized and configured so that it coextends in length and width along all or a portion of the overall length and width of the upper bed pad 32 and lower bed support 34. In many applications, the evaporator plate 20 will only coextend along a portion of overall length and width of the upper bed pad 32 and lower bed support 34. In particular embodiments, the area defined by the evaporator plate 20 will be from 20% to 100% of the overall area defined by the upper bed pad 32 and lower bed support 34. In certain embodiments, the area defined by the evaporator plate 20 will be at least equal to, and/or between any two of 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, and 100% of the overall area defined by the upper bed pad 32 and lower bed support 34. Where the evaporator plate 20 only extends along portions of the bed pad 32, the heat sink liquid 42 facilitates the dissipation of the heat across the entire surface of the upper bed pad 32 and prevents extreme concentrated cold areas of the bed pad 32 in the area immediately above the evaporator plate 20.

In some embodiments, the pet bed system 10 is provided with a heating unit 54. The heating unit 54 has a heating element 56 that is also incorporated with, embedded or otherwise contained in the lower bed support 34. The heating unit 54 may be an electric resistance-type heater with the heating element 56 being formed as a thin plate or sheet, as is shown. The plate or sheet-like heating element 56 may have similar dimensions to those described for the evaporator plate 20. Where the heating element 56 is employed, the heating element 56 and evaporator plate 20 will have areas less than the overall area of the upper bed pad 32 and lower bed support 34. Additionally, the heating element 56 and evaporator plate 20 may be sized, configured, positioned and be spaced apart so that they do not touch, overlap or otherwise interfere with one another within the lower bed support 34 and during their operation and use.

Like the evaporator plate 20, the heating element 56 may be parallel to and abut against or be positioned immediately below the upper shell wall 50. This is also adjacent to and below the lower shell wall 40 of the upper bed pad 32. As discussed previously, the upper shell wall 50 may be the same or different than the lower shell wall 40. In either case, heat is readily transferred from the heating element 56 of the lower bed support 32 through the shell walls 40, 50 to facilitate heating of the upper bed pad 32. No or only a minor amount of insulating material 46 may be interspersed between the upper surface of the heating element 56 and the upper shell wall 50. A sufficient amount of the insulating material 46 may surround or encase the ends and lower surface of the heating element 56, however, so that the majority of heat transfer to and from the heating element 56 is directed to and from its upper surface to the upper bed pad 32 and very little or minor amounts through the thickness of the layer of insulation 46 below the element 56.

The pet bed 30 with the upper bed pad 32 and lower bed support 34 may be carried or supported on a bed pad frame 58. The cooling unit 12 with the cooling unit housing 24 may also be carried on the bed pad frame 58. As shown in FIG. 1, the cooling unit 12 and housing 24 may be located at one end of the frame 58, while the pet bed 30 extends from the cooling unit housing 24 toward the opposite end of the frame 58. The frame 58 may be formed from a structurally strong, rigid material such as molded plastic, metal, fiberglass, wood, etc. The frame 58 may be configured, such as with curvatures and/or corners, to prevent or minimize areas that would allow a pet to readily chew, gnaw or bite on areas the frame 58.

The frame 58 may have a pet bed cavity or recess 60 that is sized and configured to receive the upper bed pad 32 and lower bed support 34 so that all or a portion of the pet bed 30 is received therein. When positioned in the recess 60, the pet bed 30 may be flush with the upper surface of the frame 58 or it may be project above or be recessed below the frame 58. The pet bed 30 or portions thereof and/or the cooling unit 12 and/or housing 24 may be releasably or non-releasably coupled to the frame 58. In still some embodiments, the lower bed pad 34 may be incorporated with, formed as, or otherwise be formed from all or portions of the frame 58.

The pet bed frame 58 may be collapsible or non-collapsible. If collapsible, the frame 58 may be formed from separate frame members, such as frame members 62, 64 that are releasably coupled together or otherwise movable relative to one another, such as about hinge 66, or releasable coupling for collapsing or disassembly.

The frame 58 may be provided with legs 68 to support the frame and bet ped 30 above a support surface, such as the ground or floor. The legs 68 may be short or of a height (e.g., from 1 to 10 inches) that allows the pet to readily climb onto the pet bed 30 from the support surface on which it is positioned. In certain embodiments, wheels or rollers may be provided on the frame 58 in addition to the legs 68 or wheels or rollers may replace one or more of the legs 68 to facilitate moving and transporting the pet bed system 10. The rollers can be luggage-style rollers that may pivot or rotate 360 degrees. One or more handles 70 may also be provided on the frame 58 to facilitate grasping pet bed system 10, such as during moving or transporting. In the embodiment shown, the handle 70 is formed as a recess or open area in the frame 58 that provides an area of the frame 58 that can be readily grasped. In other embodiments, the handle 70 may project from the frame 58.

The pet bed frame 58 may be sized and configured to support and contain all the elements of the pet bed system 10. In certain embodiments, the pet bed frame 58 and/or pet bed system 10 may have an overall size and configuration to fit in most commonly used pet crates. In certain applications, the pet bed frame 58 and/or pet bed system 10 may have an overall length and/or width of at least equal to, and/or between any two of 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, 25 inches, 26 inches, 27 inches, 28 inches, 29 inches, 30 inches, 31 inches, 32 inches, 33 inches, 34 inches, 35 inches, 36 inches, 37 inches, 38 inches, 39 inches, 40 inches, 41 inches, 42 inches, 43 inches, 44 inches, 45 inches, 46 inches, 47 inches, 48 inches, 49 inches, 50 inches, 51 inches, 52 inches, 53 inches, 54 inches, 55 inches, 56 inches, 57 inches, 58 inches, 59 inches, 60 inches, 61 inches, 62 inches, 63 inches, 64 inches, 65 inches, 66 inches, 67 inches, 68 inches, 69 inches, 70 inches, 71 inches, and 72 inches. In particular embodiments, a suitable size for the pet bed frame 58 and/or pet bed system 10 is that with length of from 20 inches to 60 inches and a width of from 12 to 36 inches. The overall height of the pet bed frame 58 and/or pet bed system may range from 2 inches to 20 inches. In particular embodiments, the pet bed frame 58 and/or pet bed system 10 may have an overall height of at least equal to, and/or between any two of 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, and 20 inches.

The cooling unit 12 and heating unit 54 are electrically coupled to and powered from an electrical power source. The electrical power source may be a plug-in power source, such as the electrical outlet of a home or building, a battery power source, a solar power source, a wind-turbine power source, or a combination of these. For the plug-in power source, a power cord or cable 72 of the system 10 having an electrical plug 74 may be used to plug into an existing electrical outlet socket. The power cord 72 for the plug-in power source, or other power sources that require a power cord or cable, may be an armored power cord, such as a braided or woven metal power cord. This may prevent damage to the cord 72 from the pet, such as by chewing, biting or gnawing, or from its surroundings. For plug-in power sources, the electrical power source will typically be a 120V AC power source. The power source could also be a 12V DC power source, such as commonly provided by vehicles or vehicle batteries. In such cases, the plug 74 may be configured for coupling to a cigarette-type electrical socket of an automobile. Other plug-in power sources may also be used. For battery power sources, the battery or batteries may be disposable or rechargeable, and may include rechargeable lithium-ion-type batteries that are currently in use today for many power tools and appliances. Where the pet bed system 10 is used outdoors, the power source could include a solar power source, with the system 10 being provided with solar panels (not shown), or a wind turbine that is positioned nearby for providing electrical power to the system 10.

The pet bed system 10 is further provided with a thermostat or temperature controller 76. This may regulate the amount of cooling and/or heating provided from the cooling and heating units 12, 54 to the pet bed 30. Temperature sensors (not shown) embedded in the pet bed 30, such as different portions of the upper bed pad 34, at or near the evaporator plate 20, at or near the heating element 56, etc., may be electrically or mechanically coupled to the controller 76 to provide a sensed-temperature input to the controller 76 to facilitate monitoring and regulation of the pet bed temperature. Temperature sensors may also be used to monitor the ambient air temperature and/or ambient ground surface temperature, such that the temperature of the pet bed is regulated based upon or in combination with the ambient air and/or ground surface temperatures.

The controller 76 may be coupled to or be provided with wireless transmitter and receiver such that the controller can provide an output of the sensed temperature as well as receive a signal for controlling the temperature of the pet bed system 10. This may include a cellular signal, a Wi-Fi signal, Bluetooth signal, etc., that is transmitted over a network, such as a cellular network (e.g., 3G, 4G, 5G, etc.), a local area network (LAN), a wide area network (WAN), or the connection may be made to an external computing device (for example, through the Internet using an Internet Service Provider). This may allow a user to control the pet bed system 10 remotely using their mobile phone, tablet, computer, etc. It may also allow the system 10 to receive data related to current and forecasted weather conditions that may be provided by a local or national weather or meteorological service, such as those that provide current local temperatures and weather conditions. In other embodiments, the controller 76 may be manually controlled and operated so that the thermostat or controller 76 is set at a selected temperature or temperature range for maintaining the bed temperature of the pet bed 30 at the selected temperature or temperatures.

The system 10 may be located and used outdoors or indoors. If used outdoors, the various components of the system 10 can be formed of durable, weather-resistant materials so that they are not damaged or degraded with exposure to the environment. As discussed, the system 10 may be sized to fit within an existing crate or pet housing structure (e.g., doghouse, kennel, etc.) designed and configured for the pet.

In use, a pet, such as a dog, cat, etc., may rest on the upper surface of the pet bed 30 of the pet bed system 10. During a cooling mode of operation, the heating unit 54 is turned off and the cooling unit 12 is activated to begin the refrigeration cycle so that the evaporator plate 20, which is located immediately below the lower shell wall 40 of the upper bed pad 32, is chilled. The chilled evaporator plate 20 thus chills the heat sink liquid 42 within the interior of the upper bed pad 32 to facilitate cooling of the pet bed 30, so that the pet remains comfortable during hot conditions. The heat sink liquid 42 prevents the formation of uncomfortable cold spots on the bed pad 32 and slows sudden extreme changes in temperature.

In a heating mode of operation, the cooling unit 12 is turned off and the heating unit 54 is activated to heat the heating element 56. Heat is transferred to the heat sink liquid 42 within the interior of the upper bed pad 32 to facilitate heating of the pet bed 30, so the pet remains comfortable during cold conditions. The heat sink liquid 42 prevents the formation of uncomfortable hot spots on the bed pad 32 and slows sudden extreme changes in temperature.

The pet bed system 10 may be operated so that the pet bed 30 is maintained at a selected temperature or temperature range (e.g., from 60° F. to 75° F.) at all or selected times. Alternately, the pet bed system 10 may be operated or activated when the ambient air and/or ground temperature is at, above, and/or below a selected ambient air and/or ground temperature threshold. This may be used alone or in combination with monitoring the pet bed temperature itself. In the later instance, for example, if the ambient air and/or ground temperature is at or above a selected temperature (e.g., 90° F.), the controller 76 may activate the system 10 so that it begins operation of the cooling unit 12 to cool the bed 30. While the ambient temperature is at or above the selected temperature, the controller 76 may also monitor the temperature of the pet bed 30 itself to maintain the pet bed at a selected temperature or temperature range that is below the ambient temperature (e.g., from 60° F. to 75° F.) while the ambient temperature is at or above the selected temperature. Likewise, if the temperature drops to or below a selected temperature (e.g., 50° F.), the controller 76 may activate the system 10 so that it begins operation of the heating unit 54 to heat the bed 30. While the ambient temperature is at or below the selected temperature, the controller 76 may also monitor the temperature of the pet bed itself to maintain the pet bed at a selected temperature or temperature range that is above the ambient temperature (e.g., from 60° F. to 75° F.) while the ambient temperature is at or below the selected temperature. When the ambient temperature is within a selected range that is neither too hot or cold (e.g., >50° F. and <90° F.), the controller 76 may deactivate the cooling and heating units 12, 54. Such operation saves energy and prevents the pet bed from being cooled or heated when the ambient temperatures are likely sufficient to keep the pet comfortable. In some cases, even when the ambient temperature is within a selected range that is neither too hot or too cold, the controller 76 may still monitor the temperature of the pet bed 30 itself to activate the cooling or heating units 12, 54 if it exceeds a selected threshold level. This may be used in instances where the ground temperature remains hot or cold, such as hot asphalt or concrete or ice-covered areas that cause the bed temperature to be too hot or cold, even when the ambient air temperature is comfortable.

Referring to FIG. 3, an alternate embodiment of a temperature-controlled pet bed system 80 is shown. The pet bed system 80 is similar to the pet bed system 10, previously discussed, with similar elements labeled with the same reference numerals. The system 80 differs from the system 10 in that the separate heating unit 54 is eliminated. In the system 80, a reversing valve 82 is provided that allows the cooling unit 12 to act as a heat pump. By reversing the refrigerant flow, the unit 12 can both cool and heat the pet bed 30. When the refrigerant flow is reversed from that of the cooling cycle, the evaporator 20 acts as the condenser and the condenser acts the evaporator. Refrigerant metering devices, such as the metering device 83, are required at each refrigerant coil with appropriate check valves. The metering devices 83 may be capillary tube, thermal expansion valve (TXV) or electronic expansion valve (EXV). Such a system 80 may be used in environments where there are fewer temperature extremes.

The system 80 also differs from system 10 in that the frame 58 itself forms the lower bed support 34 with the frame 58 defining an interior area for receiving the insulation material 46 and a bottom or lower wall 52 of the frame 58 forming the lower shell wall. The lower shell wall 40 of the upper bed pad 32 rests directly on the insulation layer 46 with the evaporator/condenser plate 20 abutting directly against the lower shell wall 40.

The system 80 also differs in that the condenser fan 22 of the cooling unit 12 is eliminated. Instead, the system 80 has a fan-less condenser 84 that constitutes a “hot-wall” condenser, which are often used in some refrigerators. This may make the system 80 quieter and consume less power. In the system 80, metal condenser coils 86 of the condenser 84 abut against a heat-conducting wall or “hot wall” that is supported by the frame 58. This heat conducting wall may be metal, such as steel, copper, aluminum, iron, etc., or of a material with a high thermal conductivity so that heat can be transferred by conduction between the coils 86 and the heat-conducting wall. In the embodiment shown, the lower shell wall 52 constitutes the heat conducting wall. The heat-conducting wall can also be a separate wall from the lower shell wall 52, in certain embodiments.

Where the heat-conducting wall is formed by the shell wall 52, all or portions of the lower shell wall 52 are formed from metal or other material of high thermal conductivity. The coils 86 may be held against the wall 52, by various fastening means, such as brackets or foil tape (e.g., aluminum foil tape). Moreover, the insulating material 46 surrounds the coils 86 and prevents heat from the coils 86 to be directed away from the wall 40 through the lower bed pad 34, so that heat is primarily conducted to the metal shell wall 52. The lower wall 52 should also be spaced from the support surface on which the system 80 rests so that sufficient ambient air may pass over the lower metal wall 52 to facilitate cooling of the refrigerant within the condenser coils 86.

In the embodiment of FIG. 3, in addition to legs 68, wheels or rollers 88 are provided on the frame 58 near the heat pump unit 12. A projecting handle 90 is provided on the end of the frame 58 opposite the unit 12. In this configuration, the system 80 can be moved by picking up the frame 58 with handle 90 so that the weight of the system 80 rests on wheels or rollers 88 and moved similarly to a hand truck.

The present invention provides a means for cooling pets, indoors or outdoors, while they are both awake and at rest. There are many positive benefits to pets that sleep in cooler conditions. The pet can often sleep deeper and awake more rested. This is proven in human studies and there may be more research on pets that confirms this.

The invention has several advantages over the prior art cooling methods. A direct expansion refrigerant circuit is more controllable than those passive cooling systems that utilize ice or pre-cooled material. The temperature-controlled pet bed system is inherently more efficient and reliable system than chilled water circuits, as it eliminates a secondary coolant loop requiring coolant lines and a pump. This additional equipment consumes excessive power and is subject to failure, either by a damaged pump or a coolant leak. Moreover, thermoelectric units, which are used in the many pet and human bed applications with active cooling, provide meager cooling capacity as compared to a direct expansion refrigeration system for the same equipment size. Furthermore, the heat sink material in the pet bed pad serves as a thermal storage mass, dampening the change in temperature either from the pet or from the evaporator plate or coil. The thermal mass provides a uniform temperature which is comfortable and safe for the pet.

While the invention has been shown in some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

I claim:

1. A temperature-controlled pet bed system comprising:
an electrically powered cooling unit comprising a compressor, a condenser, a refrigerant metering device, and an evaporator that are fluidly coupled together to allow a refrigerant to flow through the cooling unit in a refrigeration cycle;
a pet bed assembly configured to rest upon a support surface, the pet bed assembly comprising:
an upper bed pad containing or being configured to contain a heat sink liquid to facilitate dissipation of heat and/or cold within the upper bed pad to avoid concentrated areas of hot and/or cold from forming on the upper bed pad, the upper bed pad being configured to allow a pet to lie upon a surface of the upper bed pad; and
a lower bed support that supports the upper bed pad, the lower bed support containing the evaporator of the cooling unit, the evaporator being positioned adjacent to and below the upper bed pad so that heat is transferred between the upper bed pad and the evaporator to facilitate cooling of the upper bed pad.

2. The pet bed system of claim 1, wherein:
the metering device is a capillary tube.

3. The pet bed system of claim 1, wherein:
the lower bed support further comprises an insulating material to reduce heat transfer through the lower bed support.

4. The pet bed system of claim 1, wherein:
the evaporator is an evaporator plate.

5. The pet bed system of claim 1, wherein:
a condenser fan is provided with the condenser to facilitate cooling of condenser coils of the condenser.

6. The pet bed system of claim 1, wherein:
the pet bed assembly includes a heat-conducting wall that is exposed to ambient air, and wherein the condenser is a fan-less condenser that has a condenser coil coupled to the pet bed assembly and abuts against the heat-conducting wall so that heat is transferred between the condenser coil and heat-conducting wall.

7. The pet bed system of claim 1, further comprising:
a heating unit having a heating element contained within the lower bed support so that heat is transferred between the upper bed pad and the heating element to facilitate heating of the upper bed pad.

8. The pet bed system of claim 1, wherein:
the cooling unit further comprises a reversing valve so that the cooling unit can be operated as a heat pump unit to facilitate both cooling and heating of the upper bed pad.

9. The pet bed system of claim 1, wherein:
an upper bed pad contains a heat sink liquid of water or a water/antifreeze mixture.

10. The pet bed system of claim 1, further comprising:
a thermostat for regulating the temperature of the pet bed.

11. A temperature-controlled pet bed system comprising:
an electrically powered cooling unit comprising a compressor, a condenser, a refrigerant metering device, and an evaporator plate that are fluidly coupled together to allow a refrigerant to flow through the cooling unit in a refrigeration cycle;
a pet bed configured to rest upon a support surface and allow a pet to lie upon the upper surface of the pet bed, the pet bed comprising:
an upper bed pad formed from a polymeric shell having upper and lower shell walls that are joined together along the perimeter to define an interior of the upper bed pad, the interior of the upper bed pad containing or being configured to contain a heat sink liquid to facilitate dissipation of heat and/or cold within the upper bed pad to avoid concentrated areas of hot and/or cold from forming on the upper bed pad, the upper bed pad being configured to allow a pet to lie upon a surface of the upper bed pad; and
a lower bed support that supports the upper bed pad, the lower bed support being formed from a solid insulating material, the evaporator plate being positioned adjacent to and below the lower shell wall of the upper bed pad so that heat is transferred between the upper bed pad and the evaporator of the lower bed support to facilitate cooling of the upper bed pad.

12. The pet bed system of claim 11, wherein:
the metering device is a capillary tube.

13. The pet bed system of claim 11, wherein:
the lower bed support is formed from a polymeric shell that defines an interior of the lower bed support, and wherein the interior of the lower bed support is filled with the insulating material.

14. The pet bed system of claim 13, wherein:
the insulating material is an expanded polyurethane foam.

15. The pet bed system of claim 11, wherein:
a condenser fan is provided with the condenser to facilitate cooling of condenser coils of the condenser.

16. The pet bed system of claim 11, wherein:
the pet bed assembly includes a heat-conducting wall that is exposed to ambient air, and wherein the condenser is a fan-less condenser that has a condenser coil coupled to the pet bed assembly and abuts against the heat-conducting wall so that heat is transferred between the condenser coil and heat-conducting wall.

17. The pet bed system of claim 11, further comprising:
a heating unit having a heating element contained within the lower bed support so that heat is transferred between the upper bed pad and the heating element to facilitate heating of the upper bed pad.

18. The pet bed system of claim 11, wherein:
the cooling unit further comprises a reversing valve so that the cooling unit can be operated as a heat pump unit to facilitate both cooling and heating of the pet bed.

19. The pet bed system of claim 11, wherein:
an upper bed pad contains a heat sink liquid of water or a water/antifreeze mixture.

20. The pet bed system of claim 11, further comprising:
a thermostat for regulating the temperature of the pet bed.
